(19) United States
(12) Patent Application Publication
(10) Pub. No.: US 2009/0044413 A1
(43) Pub. Date: Feb. 19, 2009

(54) MULTIPURPOSE GARDENING SHEARS

(76) Inventor: Hwei-Rung Chou, Taipei (TW)

Correspondence Address: PAI PATENT & TRADEMARK LAW FIRM, 1001 FOURTH AVENUE, SUITE 3200, SEATTLE, WA, 98154, US

(21) Appl. No.: 11/838,820

(22) Filed: Aug. 14, 2007

(51) Int. Cl. A01G 3/02; B26B 13/00

(52) U.S. Cl. 30/254

(57) ABSTRACT

A pair of gardening shears is disclosed in which the first cutter blade has a broad first cutting edge and a narrow elongated second cutting edge at the front part and an anvil at the rear part, and the second cutter blade has a curved first cutting edge for working with the first cutting edge of the first cutter blade for pruning trees, a second cutting edge for working with the second cutting edge of the first cutter blade for trimming hedges, and a third cutting edge for working with the anvil of the first cutter blade for cutting off rotten wood.

### BACKGROUND OF THE INVENTION

(a) Field of the Invention

The present invention relates to a gardening implement and more particularly to a pair of multipurpose gardening shears, which has the combined functionality of thinning shears, hedge shears, and cut-off shears.

(b) Description of the Prior Art

Conventional gardening shears are available in numerous types. Different types of gardening shears provide different functions for different purposes. For example, pruning shears are provided for pruning trees, vines, etc., hedge shears are used for keeping hedges neat, trimmed and shaped, and cut-off shears are used for cutting off rotten wood. Each type of these gardening shears has a different shape. It is expensive to keep many different gardening shears around for different purposes. Storage and use of these gardening shears are also cumbersome.

### SUMMARY OF THE INVENTION

The present invention has been accomplished under the circumstances in view. According to one aspect of the present invention, a pair of multipurpose gardening shears comprises a first cutter blade and a second cutter blade. The first and second cutter blades are pivotally connected together for scissors action. The first cutter blade has a broad first cutting edge and a narrow elongated second cutting edge at the front part and an anvil at the rear part. The second cutter blade has a curved first cutting edge for working with the first cutting edge of the first cutter blade for pruning trees, a second cutting edge for working with the second cutting edge of the first cutter blade for trimming hedges, and a third cutting edge for working with the anvil of the first cutter blade for cutting off rotten wood.

According to another aspect of the present invention, the first cutter blade and the second cutter blade each have its respective rear part extending from the rear end of its respective front part at an angle. This angle design is a human factor engineering design that enables the user to cut trees, hedges, or rotten wood with the multipurpose gardening shears conveniently. During cutting, the cutting edges of the multipurpose gardening shears intersect with the tree, hedge, or rotten wood at about a right angle.

### BRIEF DESCRIPTION OF THE DRAWINGS

FIG. 1 is an exploded view of a pair of multipurpose gardening shears in accordance with a first embodiment of the present invention.

FIG. 2 is a perspective assembly view of the first embodiment of the present invention, showing the multipurpose gardening shears closed.

FIG. 3 corresponds to FIG. 2, showing the multipurpose gardening shears opened.

FIG. 4 is a schematic drawing showing an application example of the first embodiment of the present invention where the multipurpose gardening shears are used to prune a tree.

FIG. 5 is a schematic drawing showing another application example of the first embodiment of the present invention where the multipurpose gardening shears are used to trim hedges.

FIG. 6 is a schematic drawing showing still another application example of the first embodiment of the present invention where the multipurpose gardening shears are used to cut off rotten wood.

FIG. 7 is an elevational assembly view of a pair of multipurpose gardening shears in accordance with a second embodiment of the present invention.

### DETAILED DESCRIPTION OF THE PREFERRED EMBODIMENTS

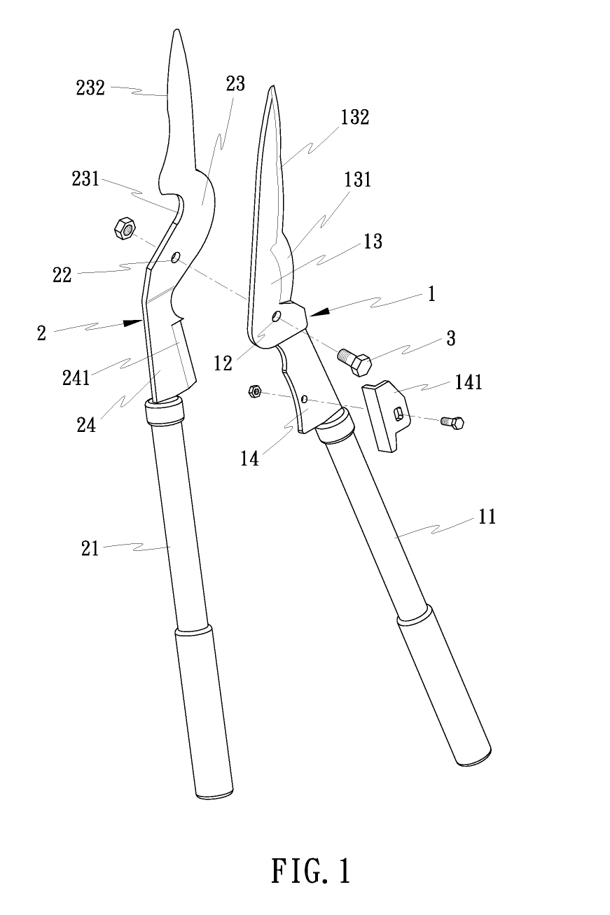

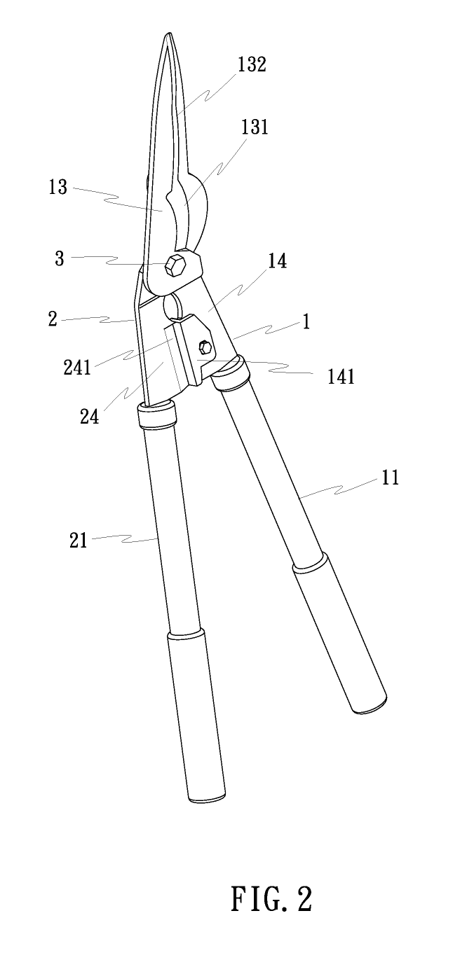

Referring to FIGS. 1˜3, a pair of multipurpose gardening shears in accordance with a first embodiment of the present invention is shown; it comprises a first cutter blade 1 and a second cutter blade 2. The first cutter blade 1 and the second cutter blade 2 are pivotally fastened together for scissors action. The cutter blades 1 and 2 each have the respective rear end respectively fixedly provided with a grip 11 or 21.

The first cutter blade 1 has a front part 13, a middle part, a rear part 14 backwardly extending from the middle part and fixedly connected with the grip 11, a pivot hole 12 disposed in a middle part between the front part 13 and the rear part 14, a first cutting edge 131 and a second cutting edge 132 formed on one lateral side of the front part 13 and extending in a direction from the proximal side of the front part 13 abutted to the middle part between the front part 13 and the rear part 14 toward the distal side of the front part 13 away from the middle part between the front part 13 and the rear part 14, and an anvil 141 fixedly provided at the rear part 14. The anvil 141 may be directly formed integral with a part of the rear part 14. Alternatively, the anvil 141 can be separately made and then fixedly fastened to the rear part 14. The first cutting edge 131 is a broad cutting edge for working with the second cutter blade 2 for pruning trees. The second cutting edge 132 is a narrow elongated cutting edge for working with the second cutter blade 2 for trimming hedges. The anvil 141 is adapted to work with the second cutter blade 2 for cutting off rotten wood.

The second cutter blade 2 has a front part 23, a middle part, a rear part 24 backwardly extending from the middle part and fixedly connected with the grip 21, a pivot hole 22 disposed in the middle part between the front part 23 and the rear part 24, a first cutting edge 231 and a second cutting edge 232 formed on the outer lateral side of the front part 23 and extending in a direction from the proximal side of the front part 23 abutted to the middle part between the front part 23 and the rear part 24 toward the distal side of the front part 23 away from the middle part between the front part 23 and the rear part 24 corresponding to the first cutting edge 131 and second cutting edge 132 of the first cutter blade 1, and a third cutting edge 241 formed on the inner lateral side of the rear part 24 corresponding to the anvil 141 at the first cutter blade 1. The first cutting edge 231 is a curved flat edge.

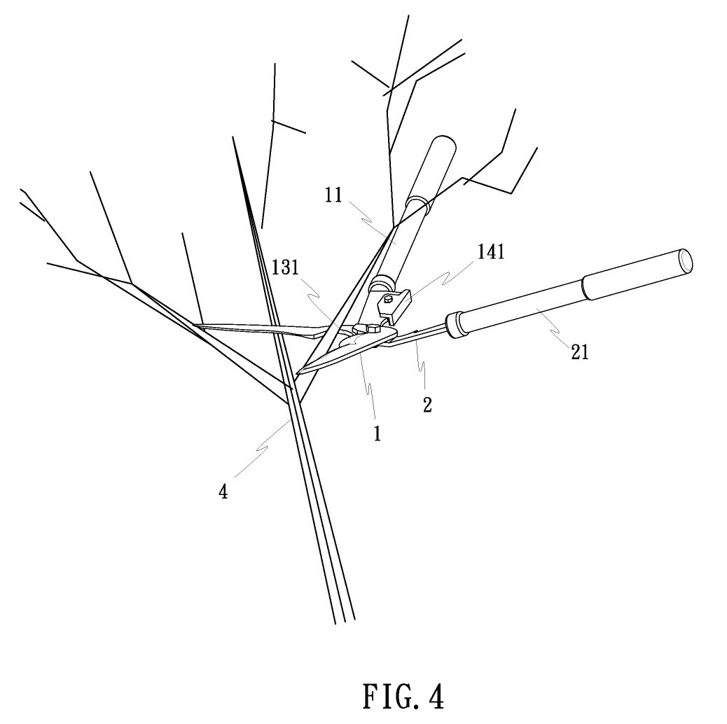

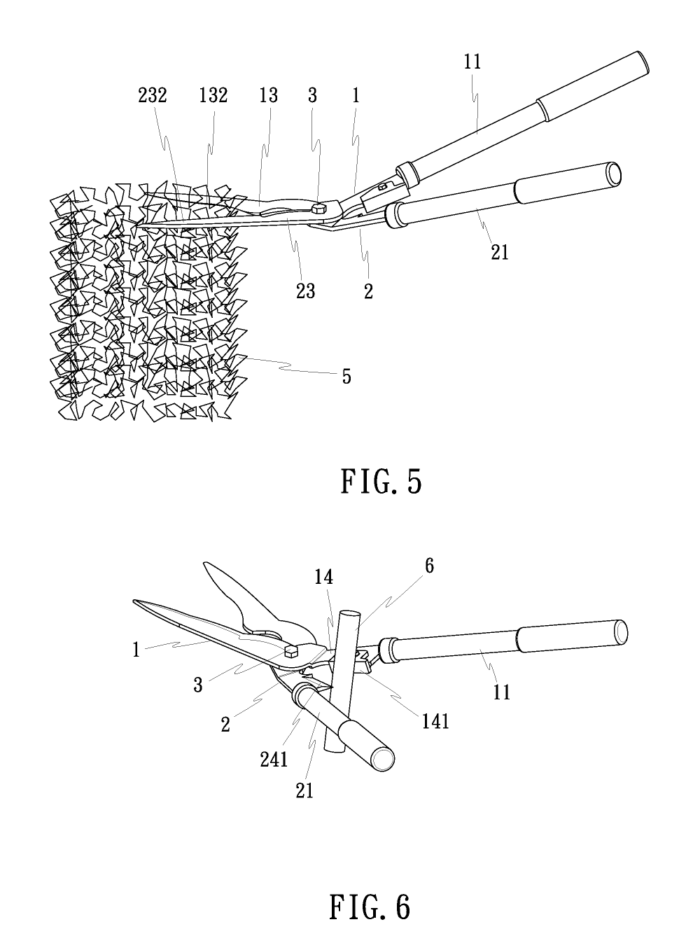

Further, a pivot device 3 is fastened to the pivot hole 12 of the first cutter blade 1 and the pivot hole 22 of the second cutter blade 2 to pivotally join the two cutter blades 1 and 2. Thus, the first cutting edge 131 of the first cutter blade 1 can work with the first cutting edge (curved flat edge) 231 of the second cutter blade 2 to prune tree branches 4 (see FIG. 4); the second cutting edge 132 of the first cutter blade 1 can work with the second cutting edge 232 of the second cutter blade 2 to trim hedges 5 (see FIG. 5); the anvil 141 of the first cutter blade 1 can work with the third cutting edge 241 of the second cutter blade 2 to cut off a piece of rotten wood 6 (see FIG. 6). Therefore, the multipurpose gardening shears provide the combined functionality of pruning shears, hedge shears, and cut-off shears.

Further, the front part 13 or 23 extends from the rear part 14 or 24 at a predetermined angle, preferably 140°˜170°. This angle design is a human factor engineering design that enables the user to cut trees, hedges, or rotten wood with the multipurpose gardening shears conveniently. During cutting, the cutting edges of the multipurpose gardening shears intersect with the tree, hedge, or rotten wood at about a right angle.

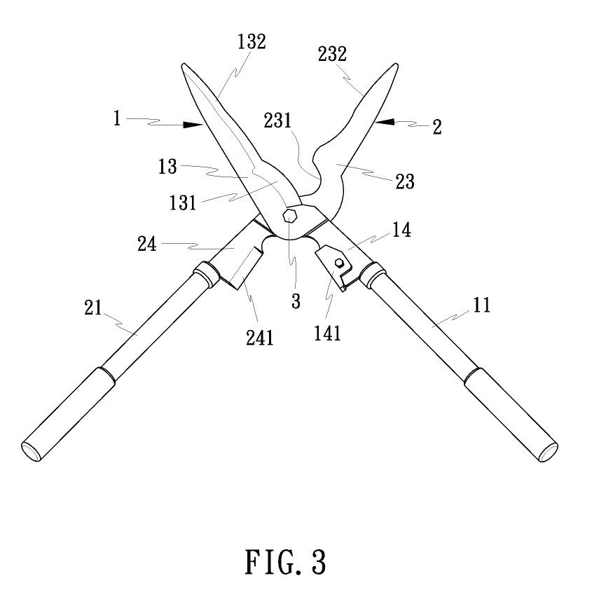

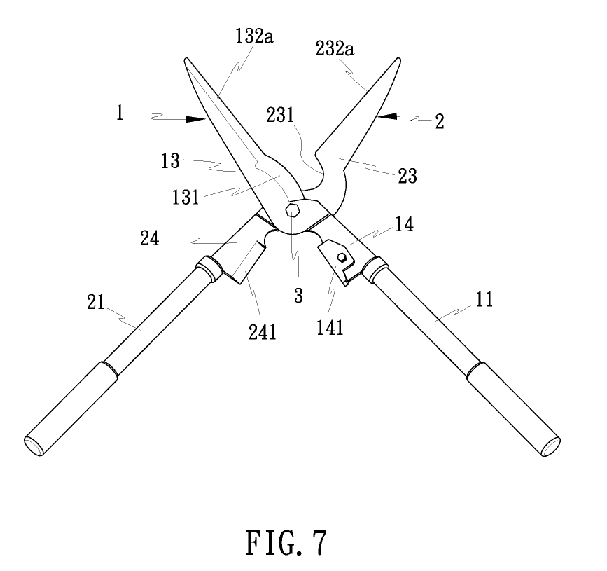

According to the aforesaid first embodiment, the second cutting edge 132 of the first cutter blade 1 and the second cutting edge 232 of the second cutter blade 2 are slightly curved at the middle (see FIGS. 1 and 3). FIG. 7 shows a pair of multipurpose gardening shears in accordance with a second embodiment of the present invention. This embodiment is substantially similar to the aforesaid first embodiment with the exception that the second cutting edge 132a of the first cutter blade 1 and the second cutting edge 232a of the second cutter blade 2 are straight cutting edges.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A pair of gardening shears comprising:
a first cutter blade having a front part, a rear part, a middle part connected between the front part and the rear part, and a pivot hole on the middle part;
a second cutter blade having a front part, a rear part, a middle part connected between the front part and the rear part, and a pivot hole on the middle part, the pivot hole of said first cutter blade being pivoted to the pivot hole of said second cutter blade for enabling said first cutter blade and said second cutter blade to make scissors action; and
two grips respectively affixed to the rear part of said first cutter blade and the rear part of said second cutter blade, wherein:
said first cutter blade has a broad first cutting edge formed on one lateral side of the front part thereof and extending in a direction from a proximal side of the front part of said first cutter blade relative to the rear part of said first cutter blade toward a distal side of the front part of said first cutter blade opposite to the proximal side of the front part of said first cutter blade, and a narrow elongated second cutting edge formed on the same lateral side of the front part of said first cutter blade and extending from one end of the first cutting edge of said first cutter blade to the distal side of the front part of said first cutter blade; and
said second cutter blade has a curved first cutting edge formed on one lateral side of the front part thereof and extending in a direction from a proximal side of the front part of said second cutter blade relative to the rear part of said second cutter blade toward a distal side of the front part of said second cutter blade opposite to the proximal side of the front part of said second cutter blade for working with the first cutting edge of said first cutter blade for pruning trees, and a second cutting edge formed on the same lateral side of the front part of said second cutter blade and extending from one end of the first cutting edge of said second cutter blade to the distal side of the front part of said second cutter blade for working with the second cutting edge of said first cutter blade for trimming hedges.

2. The gardening shears as claimed in claim 1, wherein said first cutter blade comprises an anvil fixedly provided at the rear part thereof; said second cutter blade comprises a third cutting edge formed on one lateral side of the rear part thereof for working with the anvil of said first cutter blade for cutting off rotten wood.

3. The gardening shears as claimed in claim 1, wherein the front part and the rear part of said first cutter blade define a predetermined contained angle smaller than 180°; and the front part and the rear part of said second cutter blade define a predetermined contained angle smaller than 180°.

4. The gardening shears as claimed in claim 3, wherein both of said contained angles are 140°˜170°.
